(19) United States
(12) Patent Application Publication
(10) Pub. No.: US 2026/0073111 A1
(43) Pub. Date: Mar. 12, 2026

(54) VERIFICATION METHOD, VERIFICATION APPARATUS, AND NON-TRANSITORY COMPUTER READABLE MEDIUM

(71) Applicant: Kioxia Corporation, Tokyo (JP)

(72) Inventor: Yohei KANEMURA, Yokohama (JP)

(73) Assignee: Kioxia Corporation, Tokyo (JP)

(21) Appl. No.: 19/068,058

(22) Filed: Mar. 3, 2025

(30) Foreign Application Priority Data
Sep. 9, 2024 (JP) 2024-154966

(51) Int. Cl. G06F 30/3315; G06F 119/12

(52) U.S. Cl. CPC G06F 30/3315; G06F 2119/12

(57) ABSTRACT

A verification method for an integrated circuit according to an embodiment includes: acquiring circuit operation information of an integrated circuit to be verified by a logic simulation; and analyzing the circuit operation information and extracting a verification set. The verification method according to the embodiment further includes verifying a logical operation of a location where clock domains are crossed for the verification set for each inter-flip-flop.

### CROSS REFERENCE TO RELATED APPLICATIONS

This application is based upon and claims the benefit of priority from prior Japanese Patent Application No. P2024-154966 filed on Sep. 9, 2024, the entire contents of which are incorporated herein by reference.

### FIELD

The present embodiment relates to a verification method of an integrated circuit, a verification apparatus of an integrated circuit, and a non-transitory computer readable medium.

### BACKGROUND

In a single integrated circuit, a plurality of clock signals with different signal periods may be used. In the following, a circuit block driven by one clock signal will be referred to as a “clock domain”. Crossing different clock domains will be referred to as “clock domain crossing (CDC)”. Depending on the timing of data from a transmitting side clock domain and a clock signal of a receiving side clock domain, in a location where CDC is performed (hereinafter referred to as “CDC location”), the receiving side clock domain may not be able to correctly retrieve the data. To verify signal transmission and reception operations performed between different clock domains, clock domain crossing verification (hereinafter referred to as “CDC verification”) is performed.

Conventionally, the validity of the CDC verification is confirmed by combining the CDC verification and a logic simulation. The CDC verification is performed statically.

Therefore, when a selector signal is not fixed in a location where clock signals merge such as clock multiplexer (CLKMUX), combinations that may not actually occur may be analyzed by means of the CDC verification. Due to the combinations that may not actually occur being analyzed, the number of pseudo errors tends to increase. Meanwhile, it is determined whether errors of the CDC verification are correct by performing logic simulation therefor.

Even when the CDC verification is combined with logic simulation, the number of pseudo errors of the CDC verification itself is not reduced. There have been problems that, when a large number of pseudo errors occur, it becomes relatively difficult to specify a really problematic error from among the errors of the CDC verification, and the possibility that a really problematic error is overlooked without being noticed increases. In addition, there has been a problem that, when processing for specifying a really problematic error from among the errors of the CDC verification is performed, the cost of processing time, processing equipment, and manpower increases.

### BRIEF DESCRIPTION OF THE DRAWINGS

FIG. 1 shows a flowchart of a verification method according to an embodiment.

FIG. 2 shows a detailed flowchart of step S3 in the verification method according to the embodiment.

FIG. 3A is a diagram for explaining processing of step S1 in the verification method according to the embodiment.

FIG. 3B is a diagram for explaining the processing of step S1 in the verification method according to the embodiment.

FIG. 3C is a diagram for explaining the processing of step S1 in the verification method according to the embodiment.

FIG. 4 shows a timing chart for explaining processing of step S2 in the verification method according to the embodiment.

FIG. 5 shows a timing chart for explaining processing of step S31a in the verification method according to the embodiment.

FIG. 6 shows a table for explaining processing of step S31b in the verification method according to the embodiment.

FIG. 7A shows a table for explaining processing of step S31c in the verification method according to the embodiment.

FIG. 7B shows a table for explaining processing of step S31c in the verification method according to the embodiment.

FIG. 8A shows a table for explaining processing of step S32 in the verification method according to the embodiment.

FIG. 8B shows a table for explaining the processing of step S32 in the verification method according to the embodiment.

FIG. 9A is a diagram for explaining processing of step S4 in the verification method according to the embodiment.

FIG. 9B is a diagram for explaining the processing of step S4 in the verification method according to the embodiment.

FIG. 9C is a diagram for explaining the processing of step S4 in the verification method according to the embodiment.

FIG. 9D is a diagram for explaining the processing of step S4 in the verification method according to the embodiment.

FIG. 9E is a diagram for explaining the processing of step S4 in the verification method according to the embodiment.

FIG. 10 is a schematic diagram of a verification apparatus according to an embodiment.

FIG. 11 is a block diagram of the verification apparatus according to the embodiment.

### DETAILED DESCRIPTION

An embodiment will be described with reference to the drawings. In the description of the drawings below, the same or similar parts are denoted with the same or similar reference numerals, and a description thereof will be omitted. The drawings are schematically shown.

Further, the following embodiment exemplifies an apparatus and a method for embodying the technical concept, and the embodiment does not specify the material, shape, structure, arrangement, and the like of each component. Various modifications may be made to the embodiment within the scope of claims.

One embodiment provides a verification method, a verification apparatus, and a non-transitory computer readable medium which enable suppression of pseudo errors in an integrated circuit including a CDC location.

Generally, a verification method for an integrated circuit according to an embodiment includes: acquiring circuit operation information of an integrated circuit to be verified by a logic simulation; and analyzing the circuit operation information and extracting a verification set. The verification method according to the embodiment further includes verifying a logical operation of a location where clock domains are crossed for the verification set for each inter-flip-flop.

A verification method of an integrated circuit, a verification apparatus of an integrated circuit, and a non-transitory computer readable medium of the present disclosure will be described below with reference to the drawings.

### EMBODIMENT

### Verification Method

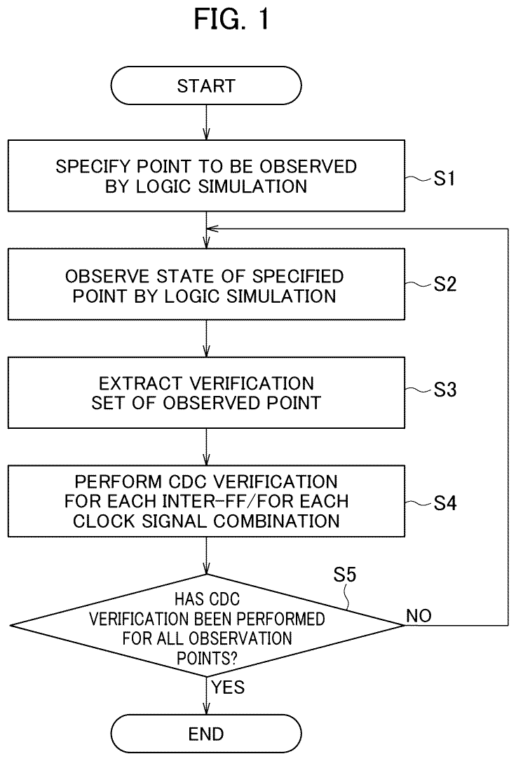

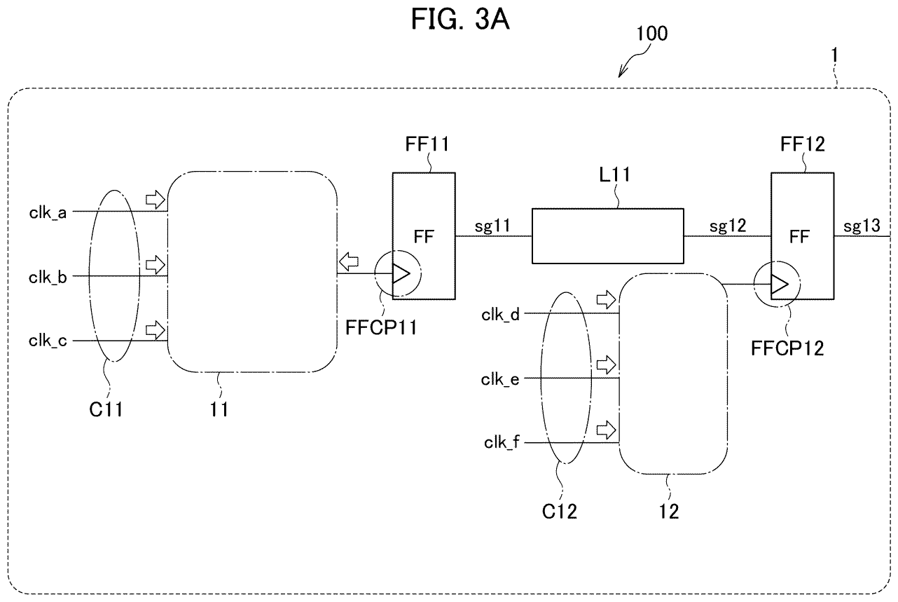

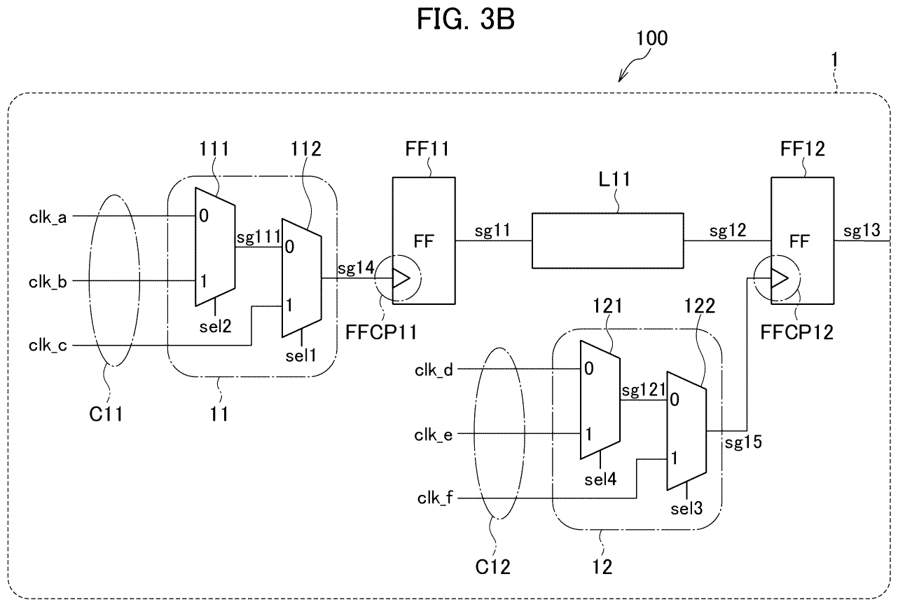

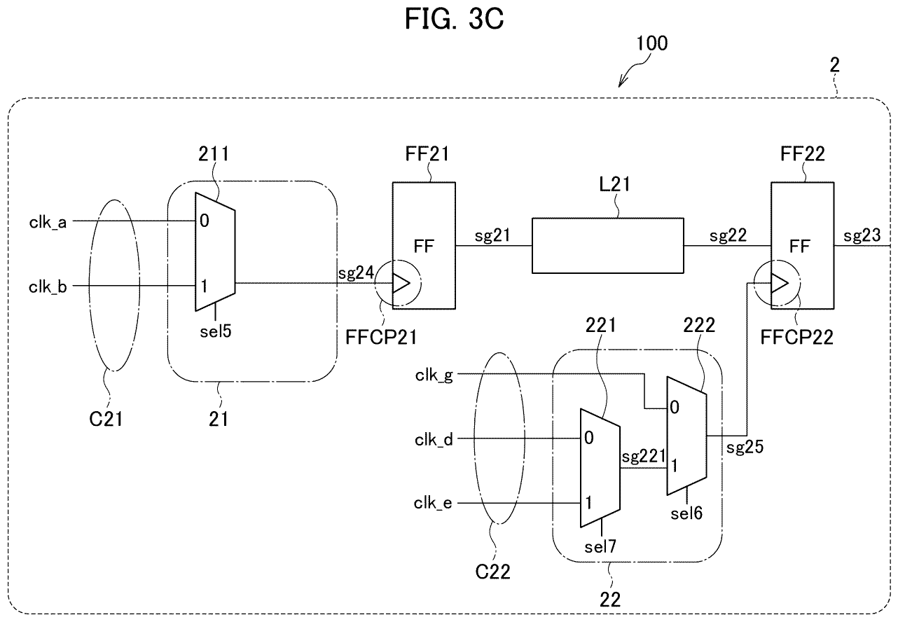

FIG. 1 shows a flowchart of a verification method according to an embodiment. The verification method according to the embodiment includes the following steps. The details of a processing method of each step will be described later with reference to FIGS. 3 to 9E, and the whole flow will be described first.

In FIG. 1, after the start of verification, in step S1, points to be observed by a logic simulation are specified. In step S2, states of the points specified in step S1 are observed by the logic simulation. In steps S1 and S2 above, operation information of an integrated circuit to be verified is obtained by the logic simulation. In step S3, circuit operation information of the points observed in step S2 (hereinafter referred to as “observation point”) are analyzed and a verification set of the observation points is extracted.

For the observation points specified in step S1, CDC verification is performed for each verification set extracted in step S3, more specifically for each inter-flip-flop (hereinafter flip-flop will be referred to as “FF”) and for each clock signal combination in step S4.

In step S5, it is determined whether the CDC verification has been performed for all observation points. If the CDC verification has not been performed for all observation points, the processing returns to step S2. The CDC verification is performed for an observation point which is not yet subjected to the CDC verification, after performing processing that has not yet been performed to the observation point. When the CDC verification has not been performed for all observation points, it is not always necessary for the processing to return to step S2. If the flow is adopted in which processing from step S1 to step S3 is performed for all observation points and then the processing proceeds to step S4, the processing may return to step S4 from step S5, for example. When the CDC verification is performed for all observation points, the verification ends.

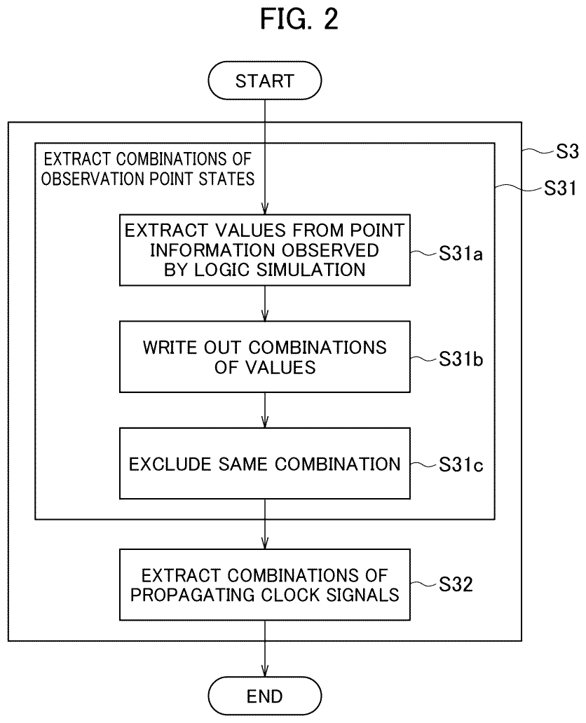

Step S3 in the flowchart of FIG. 1 has more detailed steps. FIG. 2 shows a detailed flowchart of step S3 in a verification method according to an embodiment.

In FIG. 2, after the start of step S3, combinations of observation point states are extracted in step S31. Step S31 has more detailed steps S31a, S31b, and S31c. In step S31a, values are extracted from the point information observed by the logic simulation. In step S31b, combinations of the values extracted in step S31a are written out. In step S31c, the same combination is excluded from the combinations of the values written out in step S31b.

In step S32, combinations of clock signals that propagate are extracted from combination of values obtained in step S31c and the information of the observation points specified in step S1. Step S3 ends after the end of steps S31 and S32.

Next, a description will be given below regarding the details of specific processing in each step of the flowcharts of the verification method described with reference to FIGS. 1 and 2.

FIGS. 3A, 3B, and 3C are diagrams for explaining specific processing of step S1 in the verification method according to the embodiment. In step S1, a point where different clock signals merge is traced from circuit data described in Resister Transfer Level (RTL) and data in which timing constraint is described (hereinafter referred to as “timing constraint”). Then, locations where boundaries of clock domains may be structurally crossed are extracted and specified as points to be observed by the logic simulation. Specifically, the following processing from (a1) to (b2) is performed.

(a1) In the RTL or timing constraint, a point where a “create_clock” statement defining a basic clock signal or a “create_generated_clock” statement defining a derived clock signal is described is extracted.

(a2) From the point extracted in (a1), a circuit described in the RTL is traced in a downstream direction of a signal.

(b1) In the RTL, a point where a clock pulse input pin (hereinafter referred to as “CP pin”) of an FF is defined is extracted.

(b2) From the point extracted in (b1), a circuit described in the RTL is traced in an upstream direction of the signal.

FIGS. 3A, 3B, and 3C show examples in which the above processing from (a1) to (b2) is specifically performed for an integrated circuit 100, which is an example of the integrated circuit above.

FIG. 3A shows a state in which after the start of step S1, a clock signal definition statement and a CP pin definition statement are extracted by the above processing of (a1) and (b1) in an observation point 1, which is a part of the integrated circuit 100 and the timing constraint. FIG. 3A shows a state before tracing of the processing of (a2) and (b2) is performed.

As a result of performing the processing of (a1), three clock signals clk_a, clk_b, and clk_c, which are defined by a basic clock signal definition statement or a derived clock signal definition statement, are extracted at a clock signal defining unit C11 of the integrated circuit 100 and the timing constraint in the observation point 1. In addition, three clock signals clk_d, clk_e, and clk_f, which are defined by a basic clock signal definition statement or a derived clock signal definition statement, are extracted at a clock signal defining unit C12 of the integrated circuit 100 and the timing constraint.

Meanwhile, as a result of performing the processing of (b1), a CP pin of an FF 11 which is denoted by reference numeral FFCP 11 and a CP pin of an FF 12 which is denoted by reference numeral FFCP 12 are extracted in the observation point 1.

With respect to FIG. 3A, the processing of (a2) is continuously performed to trace a circuit in which the clock signals clk_a, clk_b, and clk_c are propagated to a circuit region 11 which is located in a downstream direction of the clock signal defining unit C11 in the integrated circuit 100. Similarly, a circuit in which the clock signals clk_d, clk_e, and clk_f are propagated is traced to a circuit region 12 which is located in a downstream direction of the clock signal defining unit C12. The processing of tracing the circuits in which the clock signals are propagated to the circuit regions which are located in the downstream directions of the clock signal defining units in this way is defined as a first trace.

Further, with respect to FIG. 3A, the processing of (b2) is continuously performed to trace a circuit for generating a signal input to the CP pin FFCP 11 to the circuit region 11 in the integrated circuit 100 which is located in an upstream direction of the CP pin FFCP 11. Similarly, a circuit for generating a signal input to the CP pin FFCP 12 is traced to the circuit region 12 which is located in an upstream direction of the CP pin FFCP 12. The processing of tracing the circuits for generating the signals input to the CP pins to the circuit regions which are located in in the upstream directions of the CP pins in this way is defined as a second trace.

The trace is continued from the start of the trace to when the trace performed in the downstream direction from the clock signal defining unit C11 bumps into the trace performed in the upstream direction from the CP pin FFCP 11, and a circuit is extracted which receives a signal from the clock signal defining unit C11 and outputs a signal to the CP pin FFCP 11. Similarly, the trace is continued from the start of the trace to when the trace performed in the downstream direction from the clock signal defining unit C12 bumps into the trace performed in the upstream direction from the CP pin FFCP 12, and a circuit is extracted which receives a signal from the clock signal defining unit C12 and outputs a signal to the CP pin FFCP 12.

FIG. 3B is a diagram showing a time point when the traces described above with reference to FIG. 3A end in the circuit regions 11 and 12.

Selectors 111 and 112 are extracted in the circuit region 11, each receiving signals from the clock signal defining unit C11 and outputting a signal to the CP pin of the FF 11 denoted by FFCP 11. The selector 111 receives the clock signals clk_a and clk_b and a selection signal sel2, and outputs a post-selection clock signal sg111. The selector 112 receives the post-selection clock signal sg111, the clock signal clk_c, and a selection signal sel1, and outputs a post-selection clock signal sg14. The post-selection clock signal sg14 is input to the CP pin of the FF 11 denoted by FFCP 11.

Functions of a selector will be described using the selector 111 as an example. When a value of the selection signal sel2 is 0 (logic low level), the selector 111 selects the clock signal clk_a to be input to an input terminal denoted by “0”, and outputs the signal as a post-selection clock signal sg111. When a value of the selection signal sel2 is 1 (logic high level), the selector 111 selects the clock signal clk_b to be input to an input terminal denoted by “1”, and outputs the signal as a post-selection clock signal sg111.

Selectors 121 and 122 are extracted in the circuit region 12, each receiving signals from the clock signal defining unit C12 and outputting a signal to the CP pin of the FF 12 denoted by FFCP 12. The selector 121 receives the clock signals clk_d and clk_e and a selection signal sel4 and outputs a post-selection clock signal sg121. The selector 122 receives the post-selection clock signal sg121, the clock signal clk_f, and a selection signal sel3 and outputs a post-selection clock signal sg15. The post-selection clock signal sg15 is input to the CP pin of the FF 12 denoted by FFCP 12.

The FF 11 generates a signal sg11 based on the post-selection clock signal sg14 input to the CP pin FFCP 11, and outputs the signal sg11 from a data output terminal thereof. A logic circuit L11 is located between the two FFs denoted by FF 11 and FF 12 in the observation point 1. The signal sg11 output from the data output terminal of the FF 11 passes through the logic circuit L11 and is converted to a signal sg12, and the signal sg12 is input to a data input terminal of the FF 12. The FF 12 generates a signal sg13 based on the signal sg12 input to the data input terminal and the post-selection clock signal sg15 input to the CP pin FFCP 12, and outputs the signal sg13 from a data output terminal thereof.

At a time point when the trace in step S1 shown in FIG. 3B ends, the timing relationship between the signal sg12 and the post-selection clock signal sg15 is unclear, and therefore it is not clear whether the signals become CDC. However, the plurality of clock signals are input to the circuit for generating the signal sg12 and the post-selection clock signal sg15. Therefore, the signal sg12 and the post-selection clock signal sg15 can structurally become CDC. Therefore, in step S1, the observation point 1 including the circuit described above is extracted and specified.

FIG. 3C is a diagram showing a time point when traces of circuit regions 21 and 22 in an observation point 2 of the integrated circuit 100 end, after performing processing which is the same as the processing described with reference to FIGS. 3A and 3B for the circuit regions 21 and 22. A description of a diagram before trace is performed which is similar to FIG. 3A is omitted.

A selector 211 is extracted in the circuit region 21, which receives signals from a clock signal defining unit C21 and outputs a signal to a CP pin of an FF 21 denoted by FFCP 21. The selector 211 receives the clock signals clk_a and clk_b and a selection signal sel5, and outputs a post-selection clock signal sg24. The post-selection clock signal sg24 is input to the CP pin of the FF 21 denoted by FFCP 21.

Selectors 221 and 222 are extracted in the circuit region 22, each receiving signals from a clock signal defining unit C22 and outputting a signal to a CP pin of an FF 22 denoted by FFCP 22. The selector 221 receives the clock signals clk_d and clk_e and a selection signal sel7, and outputs a post-selection clock signal sg221. The selector 222 receives a clock signal clk_g, the post-selection clock signal sg221, and a selection signal sel6, and outputs a post-selection clock signal sg25. The post-selection clock signal sg25 is input to the CP pin of the FF 22 denoted by FFCP 22.

The FF 21 generates a signal sg21 based on the post-selection clock signal sg24 input to the CP pin FFCP 21, and outputs the signal sg21 from a data output terminal thereof. A logic circuit L21 is located between the two FFs denoted by FF 21 and FF 22 in the observation point 2. The signal sg21 output from the data output terminal of the FF 21 passes through the logic circuit L21 and is converted to a signal sg22, and the signal sg22 is input to a data input terminal of the FF 22. The FF 22 generates a signal sg23 based on the signal sg22 input to the data input terminal and the post-selection clock signal sg25 input to the CP pin FFCP 22, and outputs the signal sg23 from a data output terminal thereof.

At a time point when the trace of step S1 shown in FIG. 3C ends, the timing relationship between the signal sg22 and the post-selection clock signal sg25 is unclear, and therefore it is not clear whether the signals become CDC. However, the plurality of clock signals are input to the circuit for generating the signal sg22 and the post-selection clock signal sg25. Therefore, the signal sg22 and the post-selection clock signal sg25 can structurally become CDC. Therefore, in step S1, the observation point 2 including the circuit described above is extracted and specified.

In step S1, the processing from (a1) to (b2) is similarly performed for another observation point in the integrated circuit 100. An observation point including a circuit which can structurally become CDC is extracted and specified. When all observation points in the integrated circuit 100 are specified, step S1 ends.

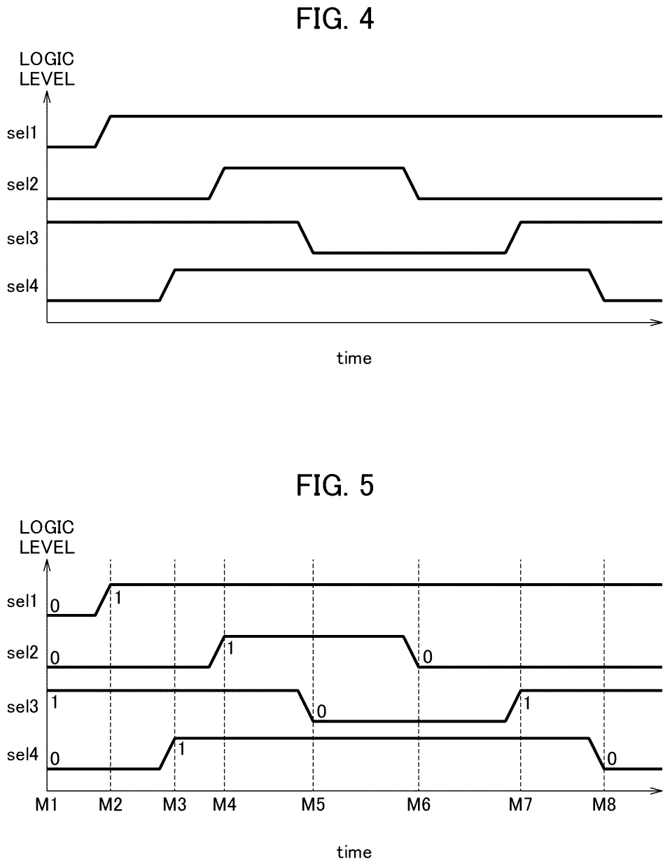

FIG. 4 is a timing chart for explaining specific processing of step S2 in the verification method according to the embodiment. In step S2, the state of the observation point specified in step S1 is observed by the logic simulation. More specifically, a control signal or output clock signal of the observation point specified in step S1 is observed by the logic simulation, and information such as a logic simulation operation waveform is output. FIG. 4 shows, as an example, a case where the state of the observation point 1 specified as shown in FIG. 3B is observed by the logic simulation, and the logic simulation operation waveform is output.

With reference to FIG. 3B, the selection signals sel2 and sel1 are input to the selectors 111 and 112 in the circuit region 11 in the specified observation point 1, respectively. Further, the selection signals sel4 and sel3 are input to the selectors 121 and 122 in the circuit region 12, respectively. FIG. 4 shows a logic simulation waveform in which the state of the selection signals sel1 to sel4 in the observation point 1 in a series of operations by the integrated circuit 100 is observed by the logic simulation.

A horizontal axis of the logic simulation waveform in FIG. 4 indicates time, and a vertical axis indicates a logic level. The logic level takes a binary value of 0 or 1, or an indefinite X (X is either 0 or 1, but it is not determined whether X is 0 or 1) not shown in FIG. 4. The logic simulation may be performed using a test vector in which an input signal for causing the integrated circuit 100 to perform an operation to be verified is described to the time axis. Alternatively, the logic simulation may be performed using a state transition diagram or a command table of the integrated circuit 100. In FIG. 4, logic levels of the selection signals sel1 to sel4 change at different timings.

If a logic simulation waveform including all nodes of the integrated circuit 100 is already present, a logic simulation waveform of the observation point may be extracted from the logic simulation waveform in step S2.

FIGS. 5, 6, 7A, 7B, 8A, and 8B are diagrams for explaining specific processing of step S3 in the verification method according to the embodiment. In step S3, the verification set of the point states observed in step S2 is extracted. The CDC verification is performed for each inter-FF. Therefore, an observation result obtained in step S2 is decomposed into combinations of states that can be taken for each inter-FF, and combinations of clock signals are reduced into combinations of clock signals that propagate. This reduces and extracts verification sets for performing the CDC verification. Step S3 includes steps S31 and S32. Step S31 includes more detailed steps S31a, S31b, and S31c.

FIG. 5 is a timing chart for explaining specific processing of step S31a included in step S31. In step S31a, values are extracted from the observation point information observed by the logic simulation in step S2. More specifically, in waveforms shown in FIG. 4 of the logic simulation obtained in step S2, a mode is divided at a timing when the state of any signal changes, as will be described later. Waveforms of the selection signals sel1 to sel4 in FIG. 5 are the same as those in FIG. 4.

In FIG. 5, combinations of the states of the selection signals sel1 to sel4 are referred to as “modes”. A series of modes that are switched on the time axis are referred to as modes M1 to MN (N is a natural number). In an initial state, the observation point 1 of the integrated circuit 100 is in mode M1. Next, when a value of the selection signal sel1 changes from 0 to 1, the mode of the observation point 1 switches to mode M2. Next, when a value of the selection signal sel4 changes from 0 to 1, the mode of the observation point 1 switches to mode M3. The same applies thereafter, and at a timing when the state of any of the selection signals sel1 to sel4 changes, the mode of the observation point 1 switches to a different mode. As the last change among those shown in FIG. 5, when a value of the selection signal sel4 changes from 1 to 0, the mode switches to mode M8.

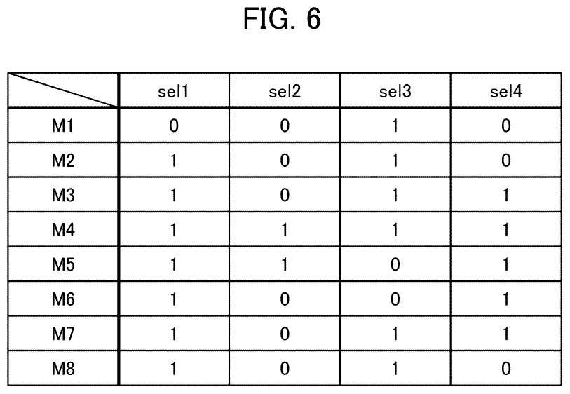

FIG. 6 is a table for explaining specific processing of step S31b included in step S31. The logic simulation waveform is divided into modes M1 to M8 in step S31a. Meanwhile, combinations of values of the selection signals sel1 to sel4 for each mode are written out in step S31b.

In the logic simulation waveform shown in FIG. 5, values of the selection signals sel1 to sel4 are 0, 0, 1, and 0 in mode M1, and are 1, 0, 1, and 0 in mode M2, for example. In FIG. 6, modes such as modes M1 and M2 are described in a row direction of the table, and the selection signals sel1 to sel4 are described in a column direction of the table. Values of the selection signals sel1 to sel4 in modes M1 and M2 are written out in the table. Writing out values of selection signals in the modes is performed for all modes in the logic simulation waveform.

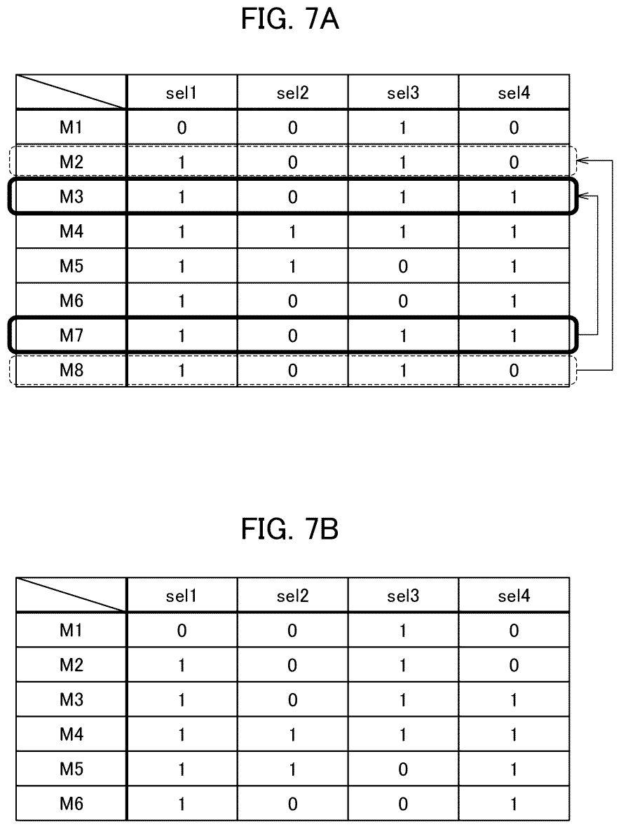

FIGS. 7A and 7B show tables for explaining specific processing of step S31c included in step S31. In step S31c, the same combination is excluded from the combinations of the values of the selection signals sel1 to sel4 for each mode written out in step S31b.

The table shown in FIG. 7A is the same as the table shown in FIG. 6. In the table shown in FIG. 7A, a combination of values of the selection signals sel1 to sel4 in mode M7 is the same as that in mode M3. Therefore, mode M3 is made to represent the combination of the values in mode M7, and mode M7 is deleted from the table. Further, a combination of values of the selection signals sel1 to sel4 in mode M8 is the same as that in mode M2. Therefore, mode M2 is made to represent the combination of the values in mode M8, and mode M8 is deleted from the table. FIG. 7B shows a table obtained by excluding the same combinations described above from the table shown in FIG. 7A, and leaving different combinations of different values.

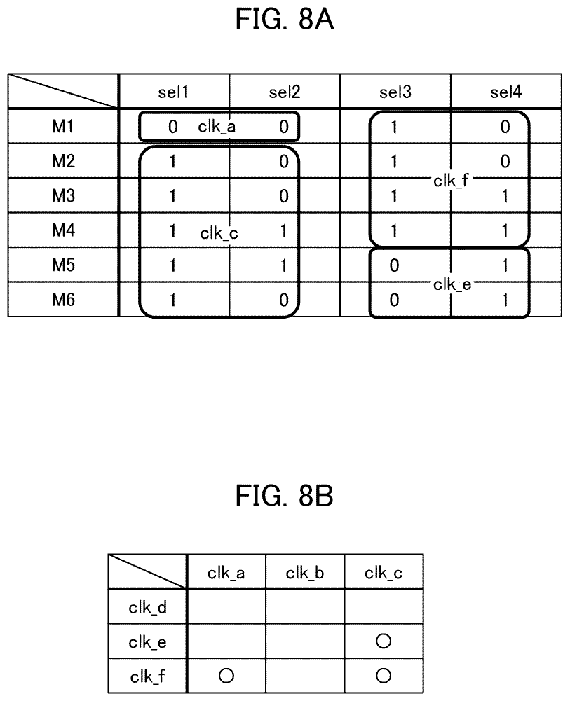

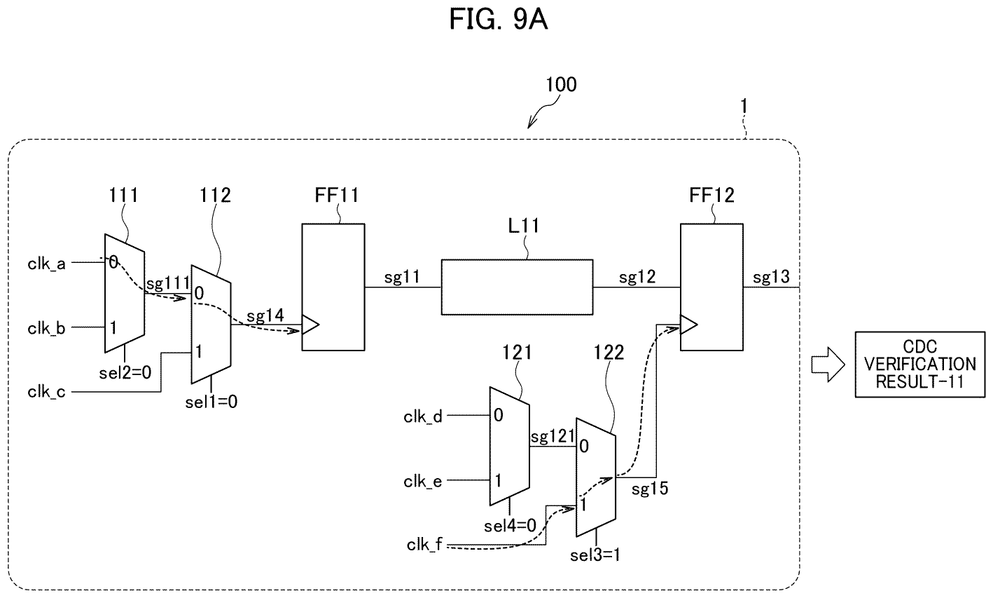

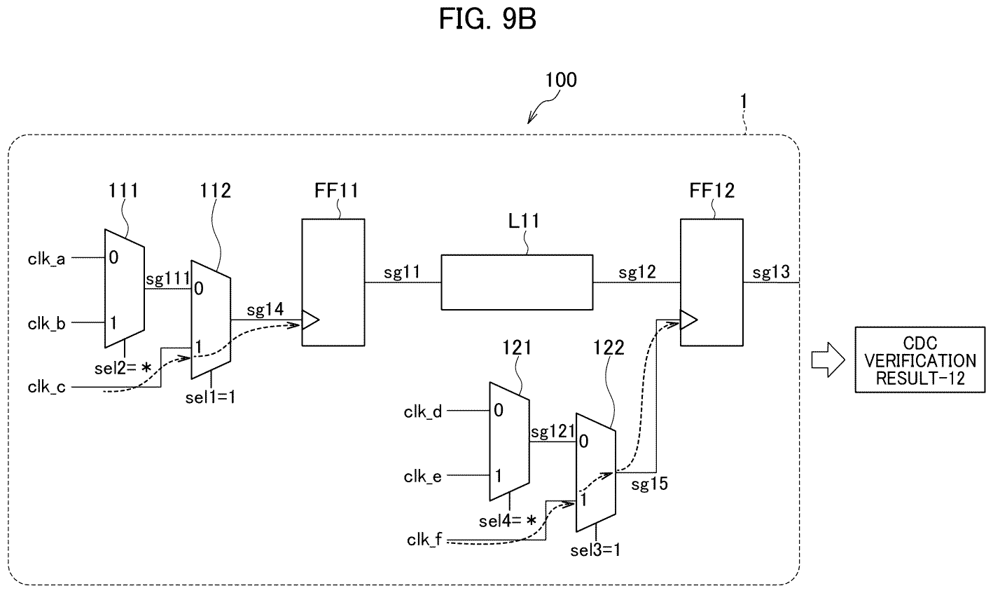

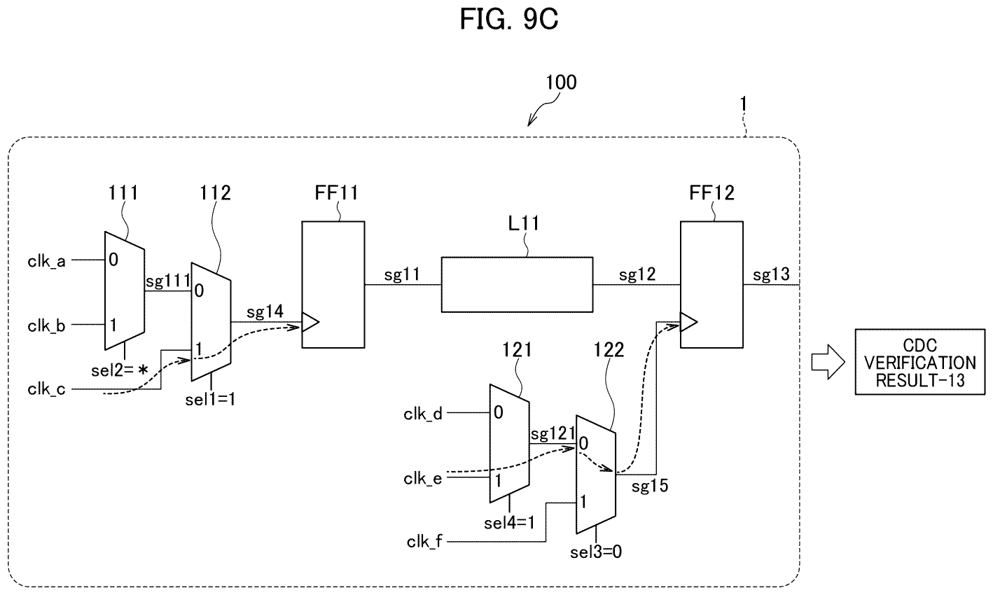

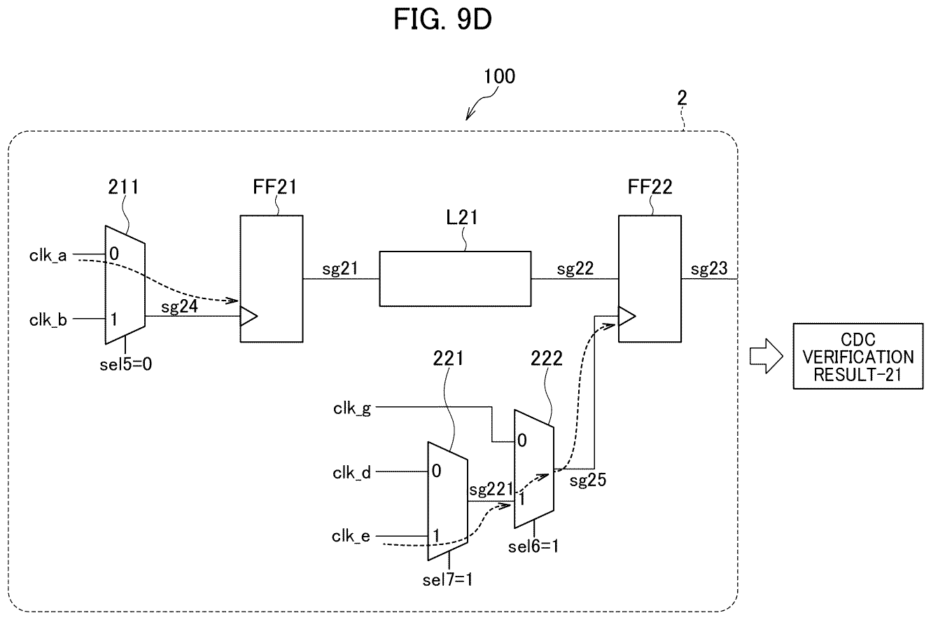

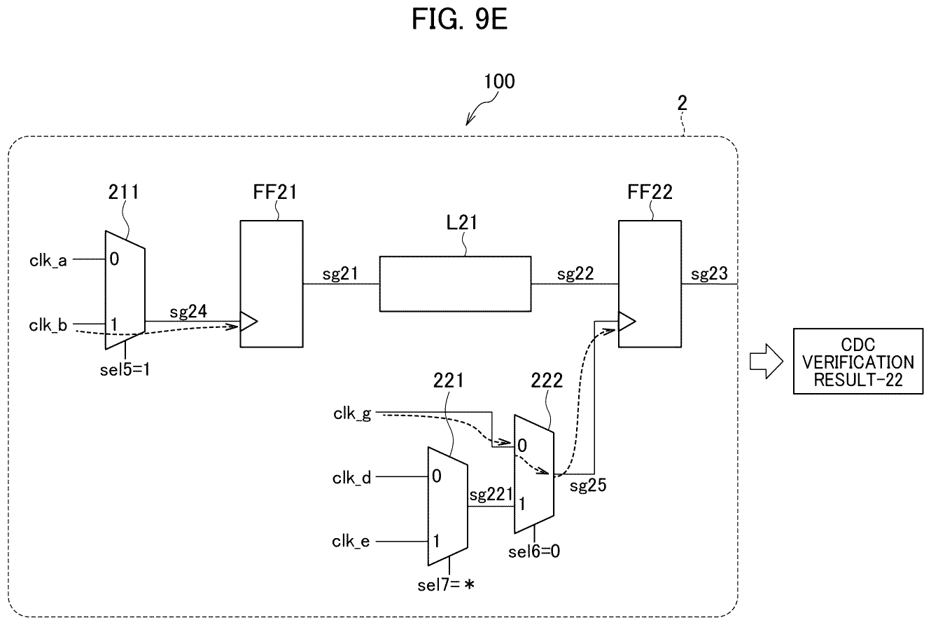

FIGS. 8A and 8B show tables for explaining specific processing of step S32. In step S32, combinations of clock signals that propagate are extracted. Further, FIGS. 9A to 9C are diagrams for explaining specific processing of step S4. The details thereof will be described later, but since FIGS. 9A to 9C show examples of combinations of clock signals that propagate extracted in step S32, a description will be given also with reference to FIGS. 9A to 9C.

Similar to the table shown in FIG. 7B, the table shown in FIG. 8A shows combinations of values of the selection signals sel1 to sel4 that can be taken in modes M1 to M8. The table shown in FIG. 8A further shows clock signals that propagate. Combinations of clock signals that propagate in each of modes M1 to M8 in the table shown in FIG. 8A are extracted as follow with reference to the table shown in FIG. 8A and the circuit of the observation point 1 shown in FIG. 3B.

With reference to FIG. 8A, in mode M1, values of the selection signals sel1 and sel2 are 0 and 0, respectively. With reference to FIG. 3B, after receiving the selection signal sel2=0, the selector 111 selects the clock signal clk_a and outputs the clock signal clk_a as the post-selection clock signal sg111. Further, after receiving the selection signal sel1=0, the selector 112 selects the post-selection clock signal sg111 and outputs the post-selection clock signal sg111 as the post-selection clock signal sg14. As described above, in mode M1, the clock signal clk_a propagates to the CP pin FFCP 11. FIG. 9A shows that the clock signal clk_a propagates to the CP pin of the FF 11 in mode M1 of the observation point 1.

Meanwhile, with reference to FIG. 8A, in mode M1, values of the selection signals sel3 and sel4 are 1 and 0, respectively. With reference to FIG. 3B, after receiving the selection signal sel4=0, the selector 121 selects the clock signal clk_d and outputs the clock signal clk_d as the post-selection clock signal sg121. Further, after receiving the selection signal sel3=1, the selector 122 selects the clock signal clk_f and outputs the clock signal clk_f as the post-selection clock signal sg15. As described above, in mode M1, the clock signal clk_f propagates to the CP pin FFCP 12. FIG. 9A shows that the clock signal clk_f propagates to the CP pin of the FF 12 in mode M1.

Next, with reference to FIG. 8A, all values of the selection signal sel1 in modes M2 to M4 are 1, and values of the selection signal sel2 in modes M2 to M4 are 0 or 1. With reference to FIG. 3B, after receiving the selection signal sel1=1, the selector 112 selects the clock signal clk_c and outputs the clock signal clk_c as the post-selection clock signal sg14.

In modes M2 to M4, values of the selection signal sel2 input to the selector 111 are 0 or 1. In either case, the post-selection clock signal sg111, which is an output of the selector 111, does not propagate to an output of the selector 112, and a clock signal propagated as the post-selection clock signal sg14 is the same. In this case, 0 and 1 of the selection signal sel2 can be used without distinction. This means that a value of the selection signal sel2 input to the selector 111 in modes M2 to M4 of the observation point 1 is in a “don't care” state, and the value will be hereinafter indicated as “sel2=*”.

As described above, in modes M2 to M4, the clock signal clk_c propagates to the CP pin FFCP 11. FIG. 9B shows that, in modes M2 to M4, the clock signal clk_c propagates to the CP pin of the FF 11.

Meanwhile, with reference to FIG. 8A, in modes M2 to M4, all values of the selection signal sel3 are 1, and values of the selection signal sel4 in modes M2 to M4 are 0 or 1. With reference to FIG. 3B, after receiving the selection signal sel3=1, the selector 122 selects the clock signal clk_f and outputs the clock signal clk_f as the post-selection clock signal sg15. The post-selection clock signal sg121, which is an output of the selector 121, does not propagate to an output of the selector 122. Therefore, the same result is obtained regardless of whether a value of the selection signal sel4 input to the selector 121 is 0 or 1. As described above, in modes M2 to M4, the clock signal clk_f propagates to the CP pin FFCP 12. FIG. 9B shows that the clock signal clk_f propagates to the CP pin of the FF 12 in modes M2 to M4.

Next, with reference to FIG. 8A, in modes M5 and M6, values of the selection signal sel1 are 1, and values of the selection signal sel2 are 0 or 1. This is similar to the case of modes M2 to M4, and therefore a detailed description is omitted. However, the clock signal clk_c propagates to the CP pin FFCP 11. FIG. 9C shows that the clock signal clk_c propagates to the CP pin of the FF 11 in modes M5 and M6.

Meanwhile, with reference to FIG. 8A, in modes M5 and M6, values of the selection signal sel3 are 0, and values of the selection signal sel4 are 1. With reference to FIG. 3B, after receiving the selection signal sel3=0, the selector 122 selects the post-selection clock signal sg121 and outputs the post-selection clock signal sg121 as the post-selection clock signal sg15. After receiving the selection signal sel4=1, the selector 121 selects the clock signal clk_e and outputs the clock signal clk_e as the post-selection clock signal sg121. As described above, in modes M5 and M6, the clock signal clk_e propagates to the CP pin FFCP 12. FIG. 9C shows that the clock signal clk_e propagates to the CP pin of the FF 12 in modes M5 and M6.

As described above, with reference to the circuit data of the observation point 1 in FIG. 3B, a combination of clock signals that propagate is extracted in each mode in the table shown in FIG. 8A, and reference numerals of clock signals that propagate are illustrated for ranges enclosed by rectangular boxes in FIG. 8A.

FIG. 8B shows a table in which a combination of clock signals that propagate in each mode is written out from the table shown in FIG. 8A. Here, the combination of clock signals refers to a combination of clock signals that may be input to two different FFs included in an observation point. In a column direction of the table shown in FIG. 8B, the clock signals clk_a, clk_b, and clk_c that may be input to the FF 11 in the observation point 1 are illustrated, and in a row direction of the table shown in FIG. 8B, the clock signals clk_d, clk_e, and clk_f that may be input to the FF 12 are illustrated. Here, the columns and rows may be switched. In the table shown in FIG. 8B, there are 3×3=9 combinations of clock signals.

FIG. 8B shows that there are combinations of clock signals represented by circle marks as combinations of clock signals that propagate. Specifically, from the table shown in FIG. 8A, since clk_a is input to the FF 11 and clk_f is input to the FF 12 in mode M1, in FIG. 8B, a circle mark is illustrated at an intersection of clk_a and clk_f. Further, from the table shown in FIG. 8A, since clk_c is input to the FF 11 and clk_f is input to the FF 12 in modes M2 to M4, in FIG. 8B, a circle mark is illustrated at an intersection of clk_c and clk_f. In addition, from the table shown in FIG. 8A, since clk_c is input to the FF 11 and clk_e is input to the FF 12 in modes M5 and M6, in FIG. 8B, a circle mark is illustrated at an intersection of clk_c and clk_e.

As described above, in the observation point 1, the number of combinations of clock signals can be reduced from 9 to 3. Although detailed description is omitted, in the observation point 2 also, the number of combinations of clock signals can be reduced in the same manner. With reference to FIG. 3C, in the observation point 2, there are two clock signals, clk_a and clk_b, which may be input to the FF 21, and there are three clock signals, clk_g, clk_d, and clk_e, which may be input to the FF 22. In the observation point 2, there are 2×3=6 combinations of clock signals. Meanwhile, by performing the same processing as that for the observation point 1, the number of combinations of clock signals that propagate can be reduced from 6.

That is, the table as shown in FIG. 8B is generated for each observation point, and a combination of clock signals that propagate in each mode in each observation point is extracted in step S32.

FIGS. 9A to 9E are diagrams for explaining specific processing of step S4 in the verification method according to the embodiment. Each inter-FF extracted in step S3 is used as a verification unit, and in step S4, for the observation point specified in step S1, the CDC verification is performed for each verification unit and for each clock signal combination to verify a logical operation. As described for step S3, since combinations of clock signals as shown in FIG. 8B can be taken as an example between FFs in the specified observation point from an operation specification, the CDC verification is performed for the combinations of the clock signals represented by the circle marks in FIG. 8B for each inter-FF.

As shown in FIG. 9A, in the observation point 1 of the integrated circuit 100, in mode M1, clk_a propagates to the FF 11 and clk_f propagates to the FF 12. The CDC verification is performed for the combination, and the verification result is output as a CDC verification result-11.

As shown in FIG. 9B, in the observation point 1, clk_c propagates to the FF 11 and clk_f propagates to the FF 12 in modes M2 to M4. The CDC verification is performed for the combination, and the verification result is output as a CDC verification result-12.

As shown in FIG. 9C, in the observation point 1, clk_c propagates to the FF 11 and clk_e propagates to the FF 12 in modes M5 and M6. The CDC verification is performed for the combination, and the verification result is output as a CDC verification results-13.

The detailed description is omitted, but as shown in FIG. 9D, in the observation point 2 of the integrated circuit 100, clk_a propagates to the FF 21 and clk_e propagates to the FF 22 in mode MN1 (N1 is a certain natural number). The CDC verification is performed for the combination, and the verification result is output as a CDC verification result-21.

As shown in FIG. 9E, in the observation point 2, clk_b propagates to the FF 21 and clk_g propagates to the FF 22 in mode MN2 (N2 is a certain natural number different from N1). The CDC verification is performed for the combination, and the verification result is output as a CDC verification result-22.

As described above, the CDC verification is performed for all observation points of the integrated circuit 100, and verification results are output. As described above, in step S5, it is determined whether the CDC verification has been performed for all observation points.

The CDC verification is performed for each inter-FF. Therefore, the processing speed of the CDC verification can be increased by decomposing a mode for each inter-FF and reducing the number of combinations of clock signals.

### Effect of Verification Method

In the verification method according to the embodiment, by performing the CDC verification based on information on a circuit operation state obtained by the logic simulation, the CDC verification can be performed for a state in which an actual operation can be performed, and therefore the occurrence of a pseudo error can be suppressed. In other words, according to the embodiment, it is possible to provide a verification method which enables suppression of the occurrence of a pseudo error in the integrated circuit including the CDC location. Further, according to the embodiment, the processing speed of the CDC verification can be increased by decomposing a mode for each inter-FF and reducing the number of combinations of clock signals.

### Verification Apparatus

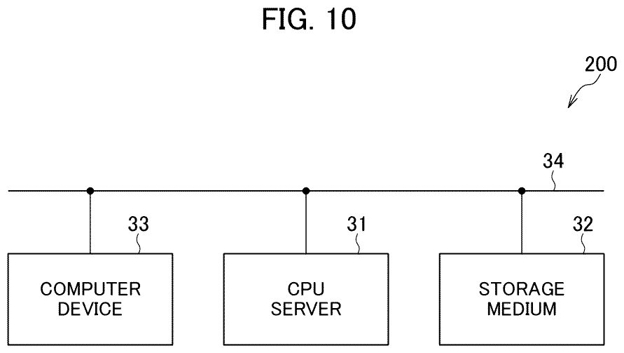

Next, a description will be given regarding a verification apparatus according to an embodiment that can perform the verification method described above. FIG. 10 is a schematic diagram of a verification apparatus 200 according to the embodiment.

As shown in FIG. 10, the verification apparatus 200 includes a central processing unit (CPU) server 31, a storage medium 32, a computer device 33, and a network 34. In the following description, the central processing unit server 31 will also be referred to as a CPU server 31.

The verification apparatus 200 connects the CPU server 31, the storage medium 32, and the computer device 33 operated by a user via the network 34. The CPU server 31 stores a computer program used for the verification apparatus 200. The storage medium 32 stores input information and output information necessary for executing the computer program used for the verification apparatus 200. The computer device 33 is operated by the user. The computer program may be stored in the storage medium 32, and the computer program may be read by and stored in the CPU server 31 when the CPU server 31 performs processing.

The CPU server 31 may be an engineering workstation, a mainframe, or a supercomputer, for example. The storage medium 32 may be an external storage device of a hard disk or Solid State Drive (SSD), a storage device of a semiconductor memory, or storage media, for example. The computer device 33 may be a personal computer (PC), a thin client terminal, a portable terminal, or a Personal Digital Assistant (PDA), for example. The network 34 may be the Internet, an intranet, a LAN, a telephone communication network, or a leased line, for example. However, the components are not limited to the examples above.

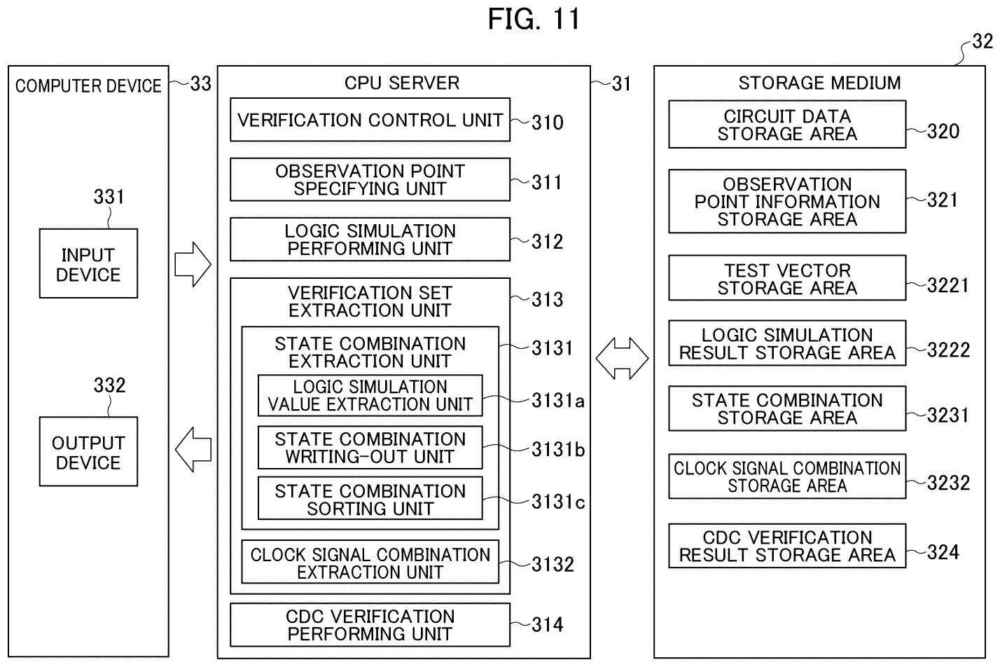

FIG. 11 is a detailed functional block diagram illustrating the CPU server 31, the storage medium 32 and the computer device 33 of the verification apparatus 200 according to the embodiment. The verification apparatus 200 includes the CPU server 31, the storage medium 32 storing data of the CPU server 31. As shown in FIG. 11, the CPU server 31 includes a verification control unit 310, an observation point specifying unit 311, a logic simulation performing unit 312, a verification set extraction unit 313, and a CDC verification performing unit 314.

The verification set extraction unit 313 includes a state combination extraction unit 3131 and a clock signal combination extraction unit 3132. The state combination extraction unit 3131 includes a logic simulation value extraction unit 3131a, a state combination writing-out unit 3131b, and a state combination sorting unit 3131c.

The verification control unit 310, the observation point specifying unit 311, the logic simulation performing unit 312, the verification set extraction unit 313, and the CDC verification performing unit 314 may be processing units such as CPUs or microprocessors, for example. However, the units are not limited to the examples above.

Further, as shown in FIG. 11, the storage medium 32 includes a circuit data storage area 320, an observation point information storage area 321, a test vector storage area 3221, and a logic simulation result storage area 3222. The storage medium 32 further includes a state combination storage area 3231, a clock signal combination storage area 3232, and a CDC verification result storage area 324.

Further, as shown in FIG. 11, the computer device 33 includes an input device 331 and an output device 332.

A processing method performed using the verification apparatus 200 shown in FIG. 11 will be described below. A designer inputs an instruction for performing the CDC verification to the input device 331 of the computer device 33. The input device 331 of the computer device 33 transmits the instruction input by the designer to the CPU server 31. The verification control unit 310 of the CPU server 31 outputs control signals to each block of the CPU server 31 and the storage medium 32.

In correspondence with step S1 in the flowchart of FIG. 1, the observation point specifying unit 311 reads data of the integrated circuit 100 and the timing constraint from the circuit data storage area 320, and performs processing for specifying the observation point. As shown in FIGS. 3B and 3C, the observation point specifying unit 311 specifies the observation point, and outputs information on the specified observation point to the observation point information storage area 321.

In correspondence with step S2 in the flowchart of FIG. 1, the logic simulation performing unit 312 performs the following processing. The logic simulation performing unit 312 reads the data of the integrated circuit 100 and the timing constraint, the specified observation point information, and the test vector information from each of the circuit data storage area 320, the observation point information storage area 321, and the test vector storage area 3221. By using the read information, the logic simulation performing unit 312 performs a logic simulation for observing the state of the specified point, and obtains a logic simulation result as shown in FIG. 4. The logic simulation performing unit 312 outputs the logic simulation result to the logic simulation result storage area 3222.

In correspondence with step S31 included in step S3 in the flowchart of FIG. 2, the state combination extraction unit 3131 of the verification set extraction unit 313 performs the following processing.

In correspondence with step S31a in the flowchart of FIG. 2, the logic simulation value extraction unit 3131a of the state combination extraction unit 3131 reads the logic simulation result from the logic simulation result storage area 3222. As shown in FIG. 5, when the state of signals in the logic simulation result changes, the logic simulation value extraction unit 3131a divides modes into such as mode M1 to mode M8, and specifies combinations of signal values such as the selection signals sel1 to sel4 in each mode.

In correspondence with step S31b in the flowchart of FIG. 2, the state combination writing-out unit 3131b of the state combination extraction unit 3131 writes out combinations of signal values in each mode, as shown in FIG. 6.

In correspondence with step S31c in the flowchart of FIG. 2, the state combination sorting unit 3131c of the state combination extraction unit 3131 excludes the same combinations from the combinations of signal values in each mode, as shown in FIG. 7B.

The state combination extraction unit 3131 outputs, to the state combination storage area 3231, information in which the same combinations have been excluded from the combinations of signal values in each mode shown in FIG. 7B.

In correspondence with step S32 included in step S3 in the flowchart of FIG. 2, the clock signal combination extraction unit 3132 of the verification set extraction unit 313 performs the following processing. The clock signal combination extraction unit 3132 reads, from the state combination storage area 3231, the information in which the same combinations have been excluded from the combinations of signal values in each mode. The clock signal combination extraction unit 3132 generates a table in which combinations of clock signals that propagate in each mode in each observation point are written out as shown in FIG. 8B, and outputs the table information to the clock signal combination storage area 3232.

In correspondence with step S4 in the flowchart of FIG. 1, the CDC verification performing unit 314 performs the following processing. The CDC verification performing unit 314 reads the data of the integrated circuit 100 and the timing constraint from the circuit data storage area 320. In addition, the CDC verification performing unit 314 reads observation point information and the table in which the combinations of clock signals that propagate in each mode in each observation point are written out, from the observation point information storage area 321 and the clock signal combination storage area 3232, respectively. As has been described with reference to FIGS. 9A to 9E, by using the read information, the CDC verification performing unit 314 performs the CDC verification for each observation point, and outputs verification results to the CDC verification result storage area 324.

In correspondence with step S5 in the flowchart of FIG. 1, the verification control unit 310 determines whether the CDC verification has been performed for all observation points. If the CDC verification has been performed for all observation points, the verification control unit 310 ends the CDC verification and outputs CDC verification results through the output device 332. Alternatively, if the CDC verification has not been performed for all observation points, the verification control unit 310 performs the same processing as described above and the CDC verification for an observation point which is not yet subjected to the CDC verification.

### Effect of Verification Apparatus

In the verification apparatus according to the embodiment, by performing the CDC verification based on information on a circuit operation state obtained by the logic simulation, the CDC verification can be performed for a state in which an actual operation can be performed, and therefore the occurrence of a pseudo error can be suppressed. According to the embodiment, it is possible to provide a verification apparatus that can perform a verification method which enables suppression of the occurrence of a pseudo error in the integrated circuit including the CDC location. Further, according to the embodiment, the processing speed of the CDC verification can be increased by decomposing a mode for each inter-FF and reducing the number of combinations of clock signals.

### Verification Program

Next, a description will be given regarding a verification program according to the embodiment which enables implementation of the verification method described above.

The verification program according to the embodiment has procedures corresponding to each step of the flowcharts of the verification method according to the embodiment shown in FIGS. 1 and 2. Specific processing by the verification program is as shown in FIGS. 3A to 9E. Further, the verification program according to the embodiment may be stored in the CPU server 31 of the verification apparatus according to the embodiment shown in FIGS. 10 and 11 and may be executed. The verification program may be stored in the storage medium 32, and the verification program may be read by and stored in the CPU server 31 when the CPU server 31 performs processing of the flowcharts of FIGS. 1 and 2.

### Effect of Verification Program

In the verification program according to the embodiment, by performing the CDC verification based on information on a circuit operation state obtained by the logic simulation, the CDC verification can be performed for a state in which an actual operation can be performed, and therefore the occurrence of a pseudo error can be suppressed. According to the embodiment, it is possible to provide a verification program that enables implementation of a verification method which enables suppression of the occurrence of a pseudo error in the integrated circuit including the CDC location. Further, according to the embodiment, the processing speed of the CDC verification can be increased by decomposing a mode for each inter-FF and reducing the number of combinations of clock signals.

### Other Embodiments

Although several embodiments of the present invention have been described above, these embodiments have been presented as examples and are not intended to limit the scope of the invention. These new embodiments may be implemented in a variety of other ways, and various omissions, substitutions, and modifications may be made without departing from the spirit of the invention. These embodiments and modification thereof are included in the scope and gist of the invention, and are also included in the invention recited in claims and the equivalent scope thereof.

In the verification method according to the embodiment, if it is determined that the CDC verification has not been performed for all observation points in step S5, the processing in the flowchart returns to step S2, for example. However, it is not always necessary for the processing to return to step S2 from step S5. If a flow is adopted in which processing from step S1 to step S3 is performed for all observation points and then the processing proceeds to step S4, the processing may return to step S4 from step S5, for example.

What is claimed is:

1. A verification method for an integrated circuit comprising:
acquiring circuit operation information of an integrated circuit to be verified by a logic simulation;
analyzing the circuit operation information and extracting a verification set; and
verifying a logical operation of a location where clock domains are crossed for the verification set for each inter-flip-flop.

2. The verification method according to claim 1, wherein
acquiring the circuit operation information includes:
specifying a point where clock signals merge; and
observing a state of the point by the logic simulation.

3. The verification method according to claim 1, wherein
the logic simulation is performed using one of a test vector in which an input signal to be input to the integrated circuit is described with respect to a time axis, a state transition diagram of the integrated circuit, and a command table of the integrated circuit.

4. The verification method according to claim 2, wherein
specifying the point includes:
a first trace of extracting definitions of the clock signals from circuit data and timing constraint, and tracing a circuit region to which the extracted clock signals are input; and
a second trace of extracting a definition of a clock pulse input pin of a flip-flop from the circuit data, and tracing a circuit region for generating a signal to be input to the extracted clock pulse input pin.

5. The verification method according to claim 2, wherein
extracting the verification set includes:
extracting a combination of states of the point from a result of the logic simulation; and
extracting a combination of clock signals that propagate from the combination of the states of the point.

6. The verification method according to claim 5, wherein
extracting the combination of the states of the point includes:
extracting a value of a control signal from information on the point;
writing out a combination of the extracted values of the control signal; and
excluding the same combination from the combination of the values.

7. The verification method according to claim 5, wherein
extracting the combination of clock signals that propagate includes:
extracting a clock signal that propagates to each of two flip-flops included in the point in each combination of the states of the point in which the same combination is excluded; and
writing out the extracted combination of clock signals that propagate to each of the two flip-flops.

8. A verification apparatus for an integrated circuit comprising:
an observation point specifying unit configured to specify a point to be observed by a logic simulation from circuit data and timing constraint;
a logic simulation performing unit configured to observe a state of the specified point by the logic simulation;
a verification set extraction unit configured to extract a verification set of the point from a result of the logic simulation;
a CDC verification performing unit configured to verify a logical operation of a location where clock domains are crossed for the verification set for each inter-flip-flop.

9. The verification apparatus according to claim 8 further comprising:
a verification control unit that outputs a control signal to the observation point specifying unit, the logic simulation performing unit, the verification set extraction unit, and the CDC verification performing unit.

10. The verification apparatus according to claim 8, wherein
the verification set extraction unit includes:
a state combination extraction unit configured to extract a combination of states of the point from the result of the logic simulation; and
a clock signal combination extraction unit configured to extract a combination of clock signals that propagate from the combination of states of the point.

11. The verification apparatus according to claim 10, wherein
the state combination extraction unit includes:
a logic simulation value extraction unit configured to extract a value of a control signal from information on the point;
a state combination writing-out unit configured to write out a combination of the extracted values; and
a state combination sorting unit configured to exclude the same combination from the combination of the values.

12. The verification apparatus according to claim 10, wherein
the CDC verification performing unit verifies a logical operation of a location where clock domains are crossed for the combination of the clock signals that propagate for each inter-flip-flop.

13. A non-transitory computer readable medium used for a verification apparatus for an integrated circuit, the non-transitory computer readable medium storing a program for causing a computer to perform:
specifying a point to be observed by a logic simulation from circuit data and timing constraint;
observing a state of the specified point by the logic simulation;
extracting a verification set of the point from a result of the logic simulation; and
verifying a logical operation of a location where clock domains are crossed for a verification set for each inter-flip-flop.

14. The non-transitory computer readable medium according to claim 13, wherein
extracting the verification set of the point includes:
extracting a combination of states of the point from a results of the logic simulation; and
extracting a combination of clock signals that propagate from the combination of states of the point.

15. The non-transitory computer readable medium according to claim 13, wherein
verifying the logical operation for the verification set includes:
verifying a logical operation of a location where clock domains are crossed for a combination of clock signals that propagate for each inter-flip-flop.
